(19) United States
(12) Patent Application Publication
(10) Pub. No.: US 2019/0213374 A1
(43) Pub. Date: Jul. 11, 2019

(54) FINGERPRINT SENSOR AND OPERATION METHOD THEREOF

(71) Applicant: SAMSUNG ELECTRONICS CO., LTD., SUWON-SI (KR)

(72) Inventors: YONGIL KWON, SUWON-SI (KR); MIN GYU KIM, SEONGNAM-SI (KR); MOONSUK JEONG, KWONSUN-GU (KR)

(21) Appl. No.: 16/058,661

(22) Filed: Aug. 8, 2018

(30) Foreign Application Priority Data
Jan. 11, 2018 (KR) 10-2018-0003770

(51) Int. Cl. G06K 9/00; G06F 3/041; G06F 21/32

(52) U.S. Cl. CPC G06K 9/0002; G06F 21/32; G06F 3/0412; G06K 9/00087

(57) ABSTRACT

A fingerprint sensor includes a fingerprint pixel that detects a fingerprint capacitance of a user fingerprint based on a first voltage and outputs fingerprint information corresponding to the detected fingerprint capacitance through a first node. A voltage conversion circuit converts the fingerprint information received through the first node to a signal, which is based on a second voltage lower than the first voltage, and outputs the converted signal. An analog circuit outputs an output signal based on the converted signal by using the second voltage.

### CR0SS-REFERENCE TO RELATED APPLICATIONS

This application claims priority under 35 U.S.C. § 119 to Korean Patent Application No. 10-2018-0003770 filed on Jan. 11, 2018, in the Korean Intellectual Property Office, the disclosure of which is incorporated by reference herein in its entirety.

### BACKGR0UND

Embodiments of the disclosure described herein relate to an electronic device, and more particularly, relate to a fingerprint sensor.

Nowadays, various types of electronic devices are being used. An electronic device performs a unique function(s) depending on operations of various electronic circuit s/modules/chips included therein. For example, the electronic device includes a computer, a smartphone, a tablet, etc. The electronic device includes many electronic circuit s/modules/chips for the purpose of providing various functions thereof.

Recent electronic devices perform a user authentication function for providing a service to an authenticated user. For example, a way to authenticate a fingerprint is widely used to grant permission authenticated by the user to an electronic device. In a fingerprint sensor, various techniques are provided to improve the accuracy of fingerprint recognition.

For example, one technique is to increase a signal to noise ratio by increasing a voltage that is used in the fingerprint sensor. However, the technique needs a separate power circuit (e.g., a power management integrated circuit (PMIC)), thereby causing an increase in manufacturing costs or a decrease in the process yield.

### SUMMARY

Embodiments of the disclosure provide a fingerprint sensor having improved reliability and reduced costs.

According to an example embodiment, a fingerprint sensor includes a fingerprint pixel that detects a fingerprint capacitor by a user fingerprint based on a first voltage and outputs fingerprint information corresponding to the detected fingerprint capacitor through a first node. A voltage conversion circuit converts the fingerprint information received through the first node to a signal, which is based on a second voltage lower than the first voltage, and outputs the converted signal. An analog circuit outputs an output signal based on the converted signal by using the second voltage.

According to an example embodiment, a fingerprint sensor has a first fingerprint pixel and a controller. The first fingerprint pixel includes a first metal electrode connected with a sensing node, a first shielding electrode connected with a shielding node, and a first pixel circuit connected with the sensing node and the shielding node. The controller controls the first pixel circuit . The first pixel circuit includes a first switch that is connected between the sensing node and the shielding node and operates in response to a first control signal or a second control signal from the controller.

According to an example embodiment, an operation method of a fingerprint sensor, having a plurality of fingerprint pixels, includes activating a first fingerprint pixel of the plurality of fingerprint pixels, disconnecting a first metal electrode and a first shielding electrode of the activated first fingerprint pixel, controlling a potential of the first shielding electrode based on control signals provided to a second fingerprint pixel adjacent to the first fingerprint pixel among the plurality of fingerprint pixels, and obtaining information about a fingerprint capacitor formed by a user fingerprint from the activated first fingerprint pixel.

According to an example embodiment, a fingerprint sensor includes a first fingerprint pixel having a first sensing electrode and a first shielding electrode, a second fingerprint pixel having a second sensing electrode and a second shielding electrode, and a control circuit . The control circuit controls the first sensing electrode to generate fingerprint information based upon a first voltage applied to the first sensing electrode and a first capacitance developed between the first sensing electrode and a fingerprint of a user. Additionally, the control circuit adjusts, while the first sensing electrode generates the fingerprint information, a second voltage applied to the first shielding electrode in accordance with third voltages applied to the second sensing electrode and second shielding electrode.

According to an example embodiment, a fingerprint pixel includes a sensing electrode, a shielding electrode, a first node directly electrically connected to the sensing electrode, a second node directly electrically connected to the shielding electrode, a first switch directly electrically connected between the first and second nodes, a second switch directly electrically connected between the second node and a first voltage tap supplying a first voltage, a third switch directly electrically connected between the second node and a third node, a fourth switch directly electrically connected between the first and third nodes, a fifth switch directly electrically connected between the third node and a second voltage tap supplying a second voltage, differing from the first voltage, and sixth and seventh switches connected in electrical series between the first node and an output node.

### BRIEF DESCRIPTION OF THE FIGURES

The above and other objects and features of the disclosure will become apparent by describing in detail exemplary embodiments thereof with reference to the accompanying drawings.

FIG. 1 is a view illustrating an electronic device according to the disclosure.

FIG. 2 is a view illustrating a fingerprint sensor of FIG. 1.

FIG. 3 is a block diagram illustrating a fingerprint sensor of FIG. 2.

FIG. 4 is a circuit diagram illustrating a fingerprint pixel, a voltage conversion circuit , and an analog circuit of FIG. 3.

FIG. 5 is a timing diagram illustrating various switching signals for driving a fingerprint sensor of FIG. 4.

FIG. 6 is a view illustrating a fingerprint sensor according to an example embodiment of the disclosure.

FIG. 7 is a view illustrating a first fingerprint pixel of FIG. 6.

FIG. 8 is a view for describing a driving manner of a fingerprint sensor of FIG. 6.

FIGS. 9A to 9D are circuit diagrams illustrating an active pixel and shielding pixels determined depending on control signals illustrated in FIG. 8.

FIG. 10 is a view for describing a driving method of a fingerprint sensor according to the disclosure.

FIG. 11 is a flowchart illustrating a driving method of a fingerprint sensor of FIG. 6.

FIG. 12 is a view illustrating an electronic device to which a fingerprint sensor according to an example embodiment of the disclosure is applied.

FIG. 13 is a block diagram illustrating an exemplary implementation of an electronic device to which a fingerprint sensor according to the disclosure is applied.

### DETAILED DESCRIPTION

Below, embodiments of the disclosure may be described in detail and clearly to such an extent that an ordinary one in the art easily implements the disclosure.

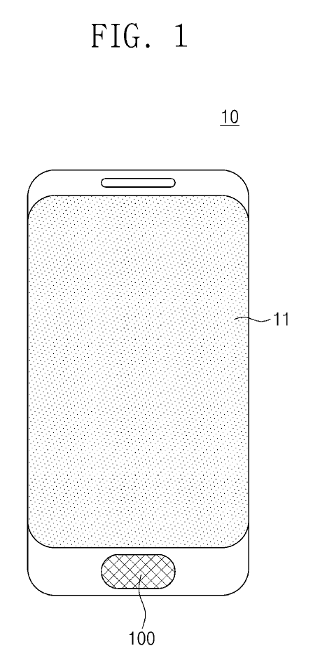

FIG. 1 is a view illustrating an electronic device 10 according to the disclosure. Referring to FIG. 1, the electronic device 10 may include a panel 11 and a fingerprint sensor 100. In an example embodiment, the electronic device 10 may be a personal portable terminal or a mobile electronic device such as a smartphone, a tablet, or a computer.

The panel 11 may provide interfacing with a user. For example, the user may view various information output from the electronic device 10 through the panel 11. Alternatively, the user may input various information to the electronic device 10 through the panel 11. To this end, the panel 11 may include a touch panel for sensing a touch of the user or a display panel for displaying information to the user.

The fingerprint sensor 100 may sense a fingerprint of the user and may perform an authentication operation based on the sensed fingerprint. That is, the fingerprint sensor 100 may be a fingerprint detection sensor or a fingerprint recognition sensor that provides a user authentication function. In an example embodiment, the fingerprint sensor according to the disclosure may be a capacitive fingerprint sensor that operates in a passive manner However, the disclosure is not limited thereto.

As illustrated in FIG. 1, the fingerprint sensor 100 may be embedded in a physical button (or a home button) of the electronic device 10. However, the disclosure is not limited thereto. The fingerprint sensor 100 may be placed at another location (e.g., a side surface or a rear surface) of the electronic device 10. Alternatively, the fingerprint sensor 100 may be provided to overlap the panel 11.

In an example embodiment, the fingerprint sensor 100 may be implemented with one chip (i.e., a single chip). For example, the fingerprint sensor 100 may include a fingerprint pixel array for detecting a fingerprint of the user and a controller for driving the fingerprint pixel array, and the fingerprint pixel array and the controller may be formed on the same semiconductor substrate.

In an example embodiment, the fingerprint pixel array included in the fingerprint sensor 100 may operate based on a first voltage level, and the controller for controlling the fingerprint pixel array included in the fingerprint sensor 100 may operate based on a second voltage level lower than a first voltage level. That is, a signal to noise ratio (SNR) for the detected fingerprint information may increase as the fingerprint pixel array of the fingerprint sensor 100 operates based on a high-voltage. Also, as the controller of the fingerprint sensor 100 operates based on a low-voltage, the fingerprint sensor 100 of high performance is provided without a separate external power circuit . An operation and a structure of the fingerprint sensor 100 will be more fully described with reference to the following drawings.

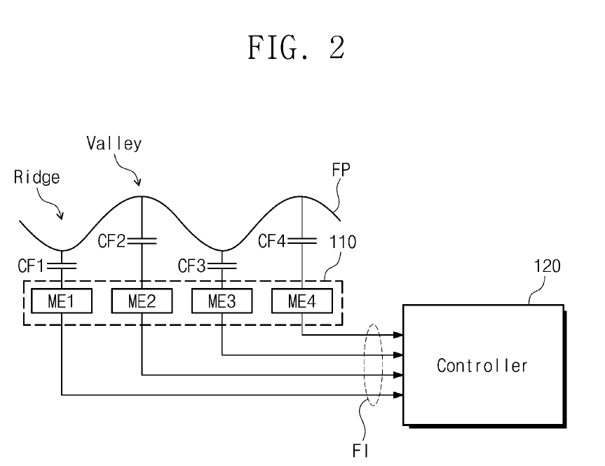

FIG. 2 is a view illustrating the fingerprint sensor 100 of FIG. 1. Referring to FIGS. 1 and 2, the fingerprint sensor 100 may include a fingerprint pixel array 110 and a controller 120. The fingerprint pixel array 110 may include a plurality of fingerprint pixels. Each of the plurality of fingerprint pixels may include a metal electrode ME for detecting a fingerprint FP of the user.

For example, the fingerprint FP of the user may be in contact with or approach first to fourth metal electrodes ME1 to ME4 of the fingerprint pixel array 110. In this case, a fingerprint capacitor may be formed between each of the first to fourth metal electrodes ME1 to ME4 and the user fingerprint FP. The fingerprint capacitor may indicate a capacitor formed between a fingerprint of the user and a metal electrode.

For example, first to fourth fingerprint capacitors CF1 to CF4 may be formed between the fingerprint FP of the user and the first to fourth metal electrodes ME1 to ME4, respectively. Values of the first to fourth fingerprint capacitors CF1 to CF4 may vary with a ridge and a valley of the user fingerprint FP.

The first and third metal electrodes ME1 and ME3 may be in contact with the ridge of the user fingerprint FP, and the second and fourth metal electrodes ME2 and ME4 may be in contact with the valley of the user fingerprint FP. In this case, values of the first and third fingerprint capacitors CF1 and CF3 on the first and third metal electrodes ME1 and ME3 may be different from values of the second and fourth fingerprint capacitors CF2 and CF4 on the second and fourth metal electrodes ME2 and ME4.

The controller 120 may receive, as fingerprint information FI, values of the first to fourth fingerprint capacitors CF1 to CF4 formed by the user fingerprint FP on the first to fourth metal electrodes ME1 to ME4 and may sense the user fingerprint FP based on the fingerprint information FI. In an example embodiment, the fingerprint information H may be an analog voltage or an analog signal that is based on a high-voltage.

In an example embodiment, the first to fourth metal electrodes ME1 to ME4 of the fingerprint pixel array 110 may be driven based on a first voltage, and the controller 120 may process the fingerprint information H, based on a second voltage lower than the first voltage.

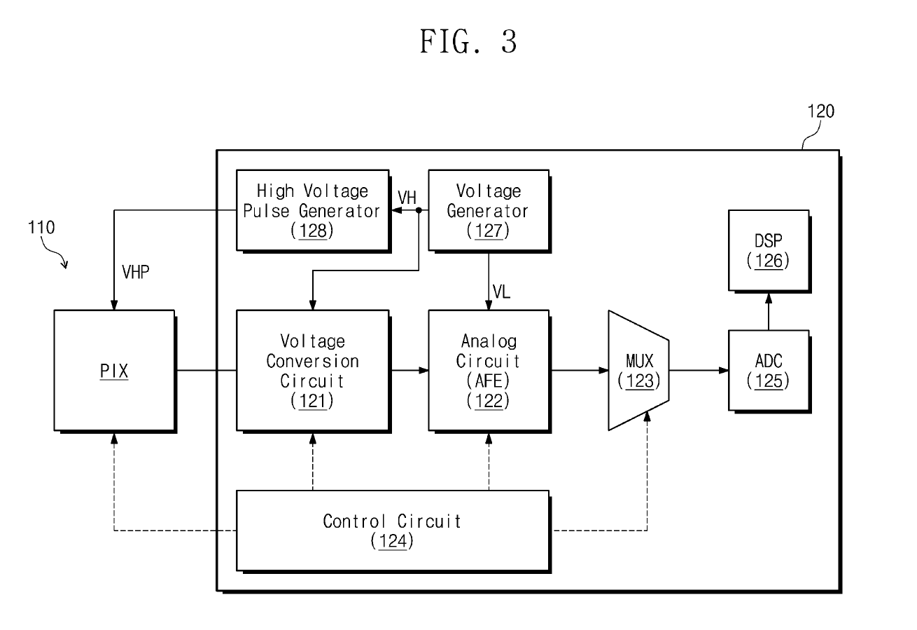

FIG. 3 is a block diagram illustrating the fingerprint sensor 100 of FIG. 2. For a brief description, one pixel of the fingerprint pixel array 110 is illustrated in FIG. 3. However, the disclosure is not limited thereto. For example, the pixel array 110 may further include a plurality of pixels. Referring to FIGS. 2 and 3, the fingerprint sensor 100 may include the fingerprint pixel array 110 and the controller 120.

The controller 120 may include a voltage conversion circuit 121, an analog circuit (analog front end: AFE) 122, a multiplexer 123, a control circuit 124, an analog to digital converter (ADC) 125, a digital signal processor (DSP) 126, a voltage generator 127, and a high-voltage pulse generator 128.

The voltage conversion circuit 121 may be configured to convert a level of the fingerprint information FI from the fingerprint pixel PIX of the fingerprint pixel array 110. For example, as described above, the fingerprint pixel PIX of the fingerprint pixel array 110 may operate based on a high-voltage. That is, various elements (e.g., a switch) included in the fingerprint pixel PIX may be a high-voltage-based element. In this case, the fingerprint information FI output from the fingerprint pixel PIX may be a signal that is based on a high-voltage level. The voltage conversion circuit 121 may convert the high-voltage level of the fingerprint information FI output from the fingerprint pixel PIX to a low-voltage level. In an example embodiment, the voltage conversion circuit 121 may perform the above-described voltage conversion operation by using a high-voltage VH from the voltage generator 127 under control of the control circuit 124.

The analog circuit 122 may be configured to process a signal converted by the voltage conversion circuit 121. For example, the analog circuit 122 may be configured to process a signal converted by the voltage conversion circuit 121 by using a low-voltage VL from the voltage generator 127 under control of the control circuit 124. That is, various elements included in the analog circuit 122 may be elements that are based on a low-voltage.

The multiplexer 123 may multiplex a signal processed by the analog circuit 122. For example, the analog circuit 122 may process the fingerprint information FI from a plurality of fingerprint pixels simultaneously or sequentially. The multiplexer 123 may sequentially provide signals processed by the analog circuit 122 to the ADC125 under control of the control circuit 124.

The control circuit 124 may control overall operations of the controller 120. For example, to detect the user fingerprint FP, the control circuit 124 may control the fingerprint pixel PIX, the voltage conversion circuit 121, the analog circuit 122, and the multiplexer 123. In an example embodiment, the control circuit 124 may generate various control signals or various switching signals, which are used to control the above-described components.

The ADC125 may convert a signal from the multiplexer 123 to a digital signal and may provide the digital signal to the digital signal processor (DSP) 126. The DSP 126 may process the digital signal from the ADC125 to finally generate an image of a user fingerprint.

The voltage generator 127 may generate the high-voltage VH and the low-voltage VL. In an example embodiment, the high-voltage VH may be a voltage that is used to drive the fingerprint pixel PIX of the fingerprint pixel array 110. The low-voltage VL may be a voltage that is used in the analog circuit 122.

The high-voltage pulse generator 128 may generate a high-voltage pulse VHP by using the high-voltage VH. In an example embodiment, the high-voltage pulse VHP may be provided to the fingerprint pixel PIX for the purpose of sensing the user fingerprint FP.

The controller 120 illustrated in FIG. 3 is exemplary, and the disclosure is not limited thereto. For example, the controller 120 may further include any other components such as a storage circuit , a reference voltage generator, an oscillator, and a timing controller.

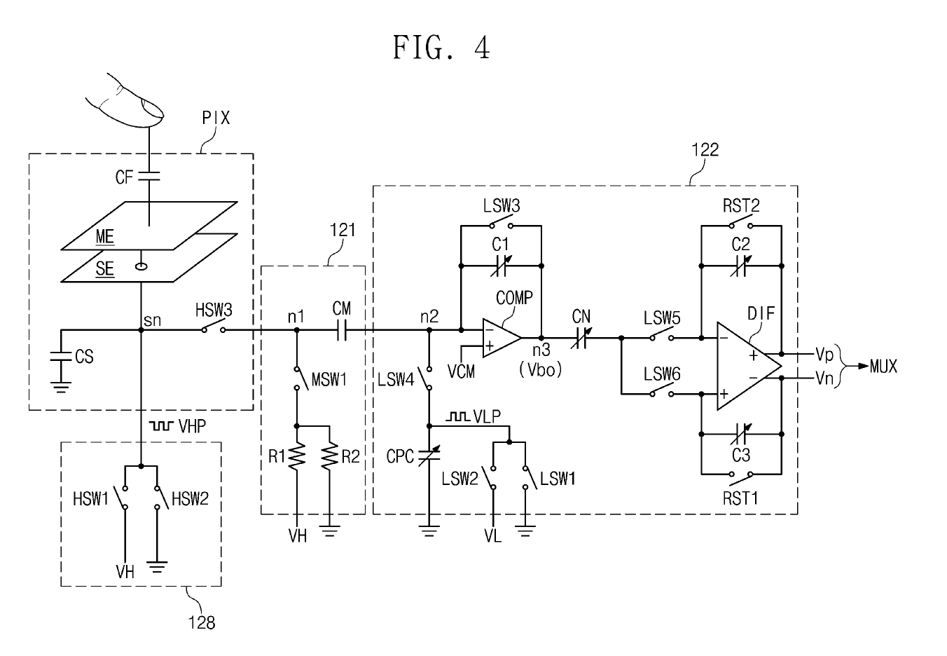

FIG. 4 is a circuit diagram illustrating the fingerprint pixel PIX, the voltage conversion circuit 121, and the analog circuit 122 of FIG. 3. In an example embodiment, the fingerprint pixel PIX, the voltage conversion circuit 121, and the analog circuit 122 illustrated in FIG. 4 are provided to describe the technical idea of the disclosure easily, and the disclosure is not limited thereto.

Also, to describe the technical idea of the disclosure easily, components are illustrated as being independent of each other. However, the disclosure is not limited thereto. For example, the voltage conversion circuit 121 may be included in the analog circuit 122, or the high-voltage pulse generator 128 may be included inside the fingerprint pixel PIX. Although not illustrated in FIG. 4, various elements illustrated in FIG. 4 may be controlled by the control circuit 124 or a separate function block.

Referring to FIGS. 3 and 4, the fingerprint sensor 100 may include the fingerprint pixel PIX, the voltage conversion circuit 121, the analog circuit 122, and the high-voltage pulse generator 128.

The high-voltage pulse generator 128 may include a first high-voltage switch HSW1 and a second high-voltage switch HSW2. A first end of the first high-voltage switch HSW1 may receive the high-voltage VH, and a second end thereof may be connected with a sensing node sn. A first end of the second high-voltage switch HSW2 may be connected with a ground terminal, and a second end thereof may be connected with the sensing node sn. The high-voltage pulse VHP may be generated by operations of the first and second high-voltage switches HSW1 and HSW2. The high-voltage pulse VHP may be provided to the fingerprint pixel PIX.

The fingerprint pixel PIX may include a metal electrode ME, a shielding electrode SE, and a third high-voltage switch HSW3. The metal electrode ME may be connected with the sensing node sn. The metal electrode ME may be an electrode for sensing a change in capacitance due to the user fingerprint FP. That is, a value that corresponds to a fingerprint capacitor CF between the metal electrode ME and the user fingerprint FP may be provided as the fingerprint information FI.

The shielding electrode SE may maintain the same potential as the metal electrode ME for the purpose of removing a parasitic capacitance formed on a substrate. That is, influence of the parasitic capacitance formed on the substrate may be removed by setting the shielding electrode SE and the metal electrode ME to the same potential.

A first end of the third high-voltage switch HSW3 may be connected with the sensing node sn, and a second end thereof may be connected with a first node nl. A value corresponding to the fingerprint capacitor CF may be provided to the first node n1 by an operation of the third high-voltage switch HSW3.

The voltage conversion circuit 121 may include a first middle switch MSW1, a first resistor R1, a second resistor R2, and a middle capacitor CM. A first end of the first middle switch MSW1 may be connected with the first node nl, and a second end thereof may be connected with a first end of the first resistor RE A second end of the first resistor R1 may be configured to receive the high-voltage VH. A first end of the second resistor R2 may be connected with the first end of the first resistor R1, and a second end thereof may be connected with the ground terminal. In an example embodiment, the first and second resistors R1 and R2 may have the same resistance value. That is, a voltage of the first node n1 may be maintained at VH/2 by an operation of the first middle switch MSW1.

The middle capacitor CM may be connected between the first node n1 and a second node n2. In an example embodiment, a value of the middle capacitor CM may be significantly great compared with the fingerprint capacitor CF. In an example embodiment, the middle capacitor CM may operate as a battery capacitor for maintaining a voltage of the first node n1 and a voltage of the second node n2 at specific voltages.

The analog circuit 122 may include first to sixth low-voltage switches LSW1 to LSW6, first and second reset switches RST1 and RST2, capacitors CPC, C1, C2, C3, and CN, a comparator COMP, and a differential circuit DIF. In an example embodiment, the capacitors CPC, C1, C2, C3, and CN may be variable capacitors for signal processing or for obtaining an appropriate signal gain.

A first end of the first low-voltage switch LSW1 may be connected with the ground terminal, and a second end thereof may be connected with a first end of the capacitor CPC. A first end of the second low-voltage switch LSW2 may be connected to receive the low-voltage VL, and a second end thereof may be connected with the first end of the capacitor CPC. A second end of the capacitor CPC may be connected with the ground terminal. The low-voltage pulse VLP may be generated by operations of the first and second low-voltage switches LSW1 and LSW2. In an example embodiment, a swing level (i.e., amplitude) of the low-voltage pulse VLP may be lower than a swing level (i.e., amplitude) of the high-voltage pulse VHP. A phase of the low-voltage pulse VLP may be opposite to a phase of the high-voltage pulse VHP.

The fourth low-voltage switch LSW4 may be connected between the second node n2 and the first end of the capacitor CPC. The low-voltage pulse VLP may be provided to the second node n2 by an operation of the fourth low-voltage switch LSW4.

A first input terminal (+) of the comparator COMP may be connected to receive a middle voltage VCM, a second input terminal (−) thereof may be connected with the second node n2, and an output terminal thereof may be connected with a third node n3. The first capacitor C1 may be connected between the second node n2 and the third node n3. The third low-voltage switch LSW3 may be connected between the second node n2 and the third node n3.

The capacitor CN may be connected between the third node n3 and a first end of the fifth low-voltage switch LSW5, and a second end of the fifth low-voltage switch LSW5 may be connected with a second input terminal (−) of the differential circuit DIF. The sixth low-voltage switch LSW6 may be connected between the first end of the fifth low-voltage switch LSW5 and a first input terminal (+) of the differential circuit DIF.

The second capacitor C2 may be connected between the second input terminal (−) and a first output terminal (+) of the differential circuit DIF, and the first reset switch RST1 may be connected between the second input terminal (−) and the first output terminal (+) of the differential circuit DIF. The third capacitor C3 may be connected between the first input terminal (+) and a second output terminal (−) of the differential circuit DIF, and the second reset switch RST2 may be connected between the first input terminal (+) and the second output terminal (−) of the differential circuit DIF. Outputs Vp and Vn from the differential circuit DIF may be provided to the multiplexer 123.

Referring to FIG. 4, the fingerprint pixel PIX may operate based on the high-voltage pulse VHP (i.e., a signal based on the high-voltage VH), and the analog circuit 122 may operate based on the low-voltage VL. In this case, the voltage conversion circuit 121 may be configured to convert a signal from the fingerprint pixel PIX from a high-voltage level to a low-voltage level such that the signal from the fingerprint pixel PIX may be used in the analog circuit 122.

In an example embodiment, since the voltage conversion circuit 121 performs a function similar to a function of a battery capacitor, voltages of the first node n1 and the second node n2 may be uniformly maintained at levels of VH/2 and VCM, respectively. In this case, only information from the fingerprint capacitor CF may be provided from the first node n1 to the second node n2. For example, the voltage Vsn of the sensing node sn may be expressed by the following Equation1.

$$Vsn = \frac{CF}{CM + CF} VH \qquad [ Equation 1 ]$$

In Equation 1, “Vsn” is a voltage of the sensing node sn, “CF” is a value of the fingerprint capacitor CF between the metal electrode ME and the user fingerprint FP, “CM” is a value of the middle capacitor CM, and “VH” is a high-voltage. In an example embodiment, the high-voltage VH may be approximately 10 V. In an example embodiment, a value of the fingerprint capacitor CF may be very small compared with a value of the middle capacitor CM. In this case, a voltage Vbo of the third node n3 may be expressed by the following Equation 2.

$$Vbo = Vsn \frac{CM}{C 1} \approx VH \frac{CF}{C 1} \qquad [ Equation 2 ]$$

In Equation 2, “Vbo” is a voltage of the third node n3, and “C1” is a capacitance value of the first capacitor C1. The remaining factors are described above, and thus, a detailed description thereof will not be repeated here. As expressed by Equation 2, in the case where a value of the middle capacitor CM is much greater than a value of the fingerprint capacitor CF, the voltage Vbo of the third node n3 may be expressed as a function for the fingerprint capacitor CF. That is, in the case where the value of the middle capacitor CM is much greater than the value of the fingerprint capacitor CF, the value of the fingerprint capacitor CF may be normally detected, and the output voltages Vp and Vn may not be almost changed due to the middle capacitor CM.

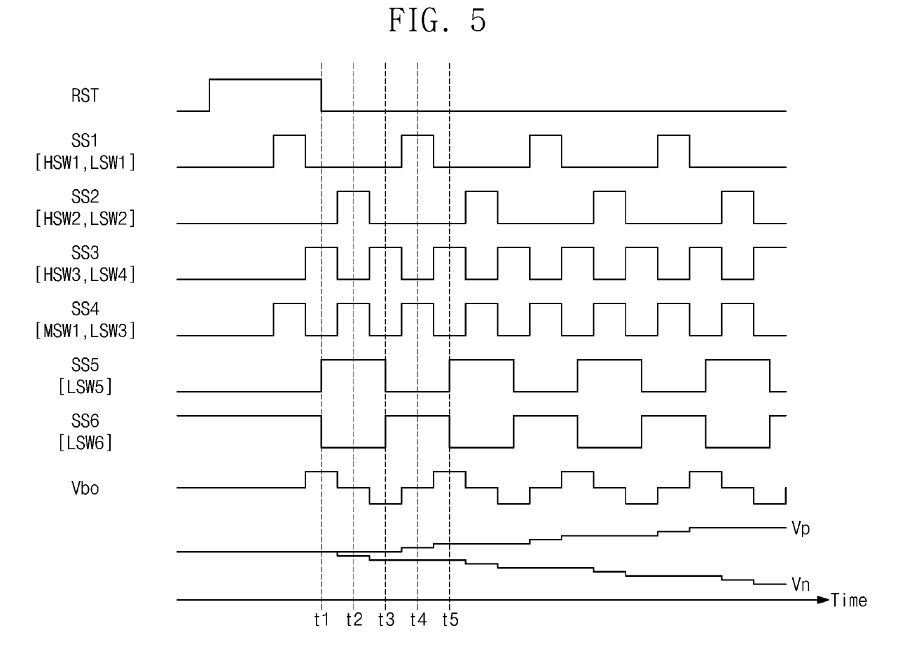

FIG. 5 is a timing diagram illustrating various switching signals for driving elements of the fingerprint sensor 100 of FIG. 4. For a brief description, first to sixth switching signals SS1 to SS6 for driving respective switches are exemplified in FIG. 5. For convenience of description, it is assumed that a switch is turned on in the case where a switching signal corresponding to the switch is at a high level and is turned off in the case where the switching signal is at a low level. However, the disclosure is not limited thereto.

Referring to FIGS. 3 to 5, the control circuit 124 may generate the first to sixth switching signals SS1 to SS6. The first and second reset switches RST1 and RST2 may operate in response to a reset signal RST. The first high-voltage switch HSW1 and the first low-voltage switch LSW1 may operate in response to the first switching signal SS1. The second high-voltage switch HSW2 and the second low-voltage switch LSW2 may operate in response to the second switching signal SS2.

The third high-voltage switch HSW3 and the fourth low-voltage switch LSW4 may operate in response to the third switching signal SS3. The middle switch MSW1 and the third low-voltage switch LSW3 may operate in response to the fourth switching signal SS4. In an example embodiment, the third and fourth switching signals SS3 and SS4 may be complementary.

The fifth low-voltage switch LSW5 may operate in response to the fifth switching signal SSS. The sixth low-voltage switch LSW6 may operate in response to the sixth switching signal SS6.

Continuing to refer to FIGS. 3 to 5, the first and second reset switches RST1 and RST2 are turned on in response to the reset signal RST of the high level. In this case, levels of the first and second output voltages Vp and Vn may be reset.

Afterwards, at a first time-point t1, the third high-voltage switch HSW3 and the fourth low-voltage switch LSW4 may be turned on in response to the third switching signal SS3. In this case, a voltage of the sensing node sn may be provided to the second node n2 by an operation of the third high-voltage switch HSW3, and thus, the voltage Vbo may increase by a predetermined level.

Afterwards, at a second time-point t2, the second high-voltage switch HSW2 and the second low-voltage switch LSW2 may be turned on in response to the second switching signal SS2. In this case, the high-voltage pulse VHP is a ground voltage, and the low-voltage pulse VLP is the low-voltage VL. Also, as the middle switch MSW and the third low-voltage switch LSW3 are turned on in response to the fourth switching signal SS4, a voltage of the first node n1 is VH/2, and a voltage of the second node n2 and the voltage Vbo of the third node n3 are the middle voltage VCM. As the fifth low-voltage switch LSW5 is turned on in response to the fifth switching signal SS5, the second output voltage Vn may decrease by a predetermined level. The reason is that the voltage Vbo decreases.

Afterwards, at a third time-point t3, the third high-voltage switch HSW3 and the fourth low-voltage switch LSW4 may be turned on in response to the third switching signal SS3. In this case, a voltage of the sensing node sn may be provided to the second node n2 by an operation of the third high-voltage switch HSW3, and thus, the voltage Vbo may decrease by a predetermined level. The reason is that the voltage of the sensing node sn decreases to a ground level by the operation corresponding to the second time-point t2. The second output voltage Vn may decrease by a predetermined level depending on a change in the voltage Vbo of the third node n3.

Afterwards, at a fourth time-point t4, the first high-voltage switch HSW1 and the first low-voltage switch LSW1 may be turned on in response to the first switching signal SS1. In this case, the high-voltage pulse VHP is the high-voltage VH, and the low-voltage pulse VLP is the ground voltage. Also, as the middle switch MSW and the third low-voltage switch LSW3 are turned on in response to the fourth switching signal SS4, a voltage of the first node n1 is VH/2, and a voltage of the second node n2 is the middle voltage VCM. Accordingly, the voltage of the third node n3 may be the middle voltage VCM. As the sixth low-voltage switch LSW6 is turned on in response to the sixth switching signal SS6, the first output voltage Vp may increase by a predetermined level.

Afterwards, at a fifth time-point t5, the third high-voltage switch HSW3 and the fourth low-voltage switch LSW4 may be turned on in response to the third switching signal SS3. In this case, a voltage of the sensing node sn may be provided to the second node n2 by an operation of the third high-voltage switch HSW3, and thus, the voltage Vbo may increase by a predetermined level. The reason is that the voltage of the sensing node sn increases to a high-voltage level by the operation corresponding to the fourth time-point t2. The first output voltage Vp may increase by a predetermined level depending on a change in the voltage Vbo of the third node n3.

As the above operation is repeatedly performed, the first output voltage Vp may gradually increase, and the second output voltage Vn may gradually decrease. An output voltage that is finally output may be expressed by the following Equation 3.

$$Vp , Vn = [ VH \frac{CF + CS}{C 1} - VL \frac{CPC}{C 1} ] \frac{CN}{C 2} N \qquad [ Equation 3 ]$$

In Equation 3, “Vp” and “Vn” indicate first and second output voltages, respectively, “CS” indicates a parasitic capacitance value between the sensing node sn and the substrate as illustrated in FIG. 4, and “CPC” indicates a capacitance value of the capacitor CPC. “CN” indicates a value of the capacitor CN, “C2” indicates a value of the second capacitor C2, and “N” indicates the number of times of integration. That is, the analog circuit 122 of FIG. 4 may include an integrator configured to integrate a signal of the second node n2. In an example embodiment, the integrator may include the third to sixth low-voltage switches LSW3 to LSW6, the first and second reset switches RST1 and RST2, the capacitors C1, C2, C3, and CN, the comparator COMP, and the differential circuit DIF of the analog circuit 122 of FIG. 4.

As expressed by Equation 3, the analog circuit 122 may accumulate a signal from the fingerprint pixel PIX to output the first and second output voltages Vp and Vn. In this case, as described with reference to Equation 2, in the case where a value of the middle capacitor CM is very great compared with a value of the fingerprint capacitor CF, the voltage Vbo of the third node n3 may be the same as a value calculated by Equation 2. In the case of combing Equation 2 and Equation 3, the final output voltages Vp and Vn may be expressed as a function of the voltage Vbo of the third node n3. Also, as expressed by Equation 2, the voltage Vbo of the third node n3 may be a function for the fingerprint capacitor CF.

That is, in conclusion, the first and second output voltages Vp and Vn output from the analog circuit 122 according to the disclosure may be expressed as a function for the fingerprint capacitor CF. In other words, a value of the fingerprint capacitor CF may be derived based on the first and second output voltages Vp and Vn, and information about the user fingerprint FP may be obtained based on the derived value.

As described above, the fingerprint sensor 100 according to the disclosure may finally obtain information about a user fingerprint by driving the fingerprint pixel PIX by using the high-voltage VH and processing a signal from the fingerprint pixel PIX by using the low-voltage VL. That is, a signal to noise ratio (SNR) of an output signal from the fingerprint pixel PIX may increase by driving the fingerprint pixel PIX by using the high-voltage VH. Also, the fingerprint sensor 100 may be driven without a separate external power source and a separate power circuit by driving the analog circuit 122 by using the low-voltage VL. Accordingly, a fingerprint sensor of improved performance is provided with reduced costs.

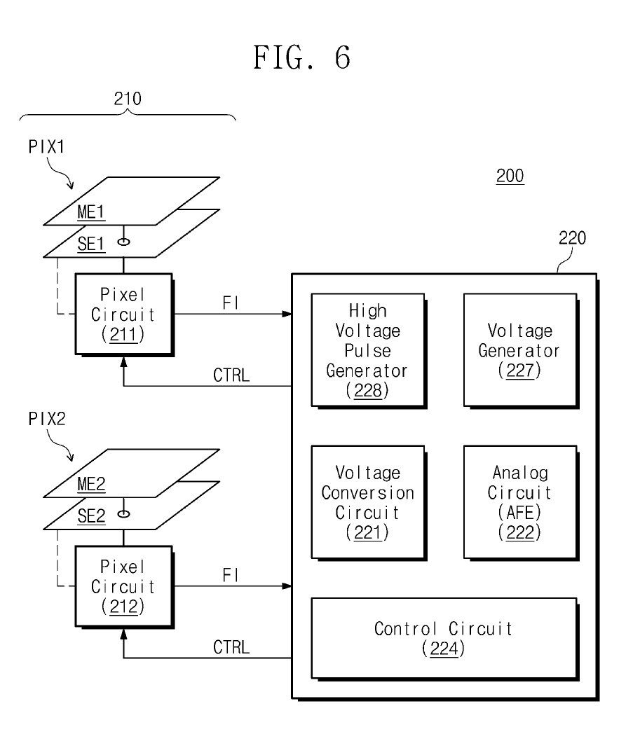

FIG. 6 is a view illustrating a fingerprint sensor 200 according to an example embodiment of the disclosure. For a brief description, two fingerprint pixels PIX1 and PIX2 are illustrated in FIG. 6, but the disclosure is not limited thereto.

Referring to FIG. 6, the fingerprint sensor 200 may include a fingerprint pixel array 210 and a controller 220. The controller 220 may include a voltage conversion circuit 221, an analog circuit 222, a control circuit 224, a voltage generator 227, and a high-voltage pulse generator 228. The controller 220, the voltage conversion circuit 221, the analog circuit 222, the control circuit 224, the voltage generator 227, and the high-voltage pulse generator 228 are respectively similar to the controller 120, voltage conversion circuit 121, analog circuit 122, control circuit 124, voltage generator 127, and high-voltage pulse generator 128 described above, and thus, a description thereof will not be repeated here.

The fingerprint pixel array 210 may include the first and second fingerprint pixels PIX1 and PIX2. The first fingerprint pixel PIX1 may include a first metal electrode ME1 a first shielding electrode SE1, and a first fingerprint pixel circuit 211. The second fingerprint pixel PIX2 may include a second metal electrode ME2, a second shielding electrode SE2, and a second fingerprint pixel circuit 212. Below, since the first and second fingerprint pixels PIX1 and PIX2 have similar structures, an example embodiment of the disclosure will be described with reference to the first fingerprint pixel PIX1.

The first metal electrode ME1 of the first fingerprint pixel PIX1 that is an electrode being in contact with the user fingerprint FP may be an electrode for detecting the fingerprint capacitor CF. The first shielding electrode SE1 may be an electrode that is driven with a specific voltage for the purpose of removing influence of a parasitic capacitor between the first metal electrode ME1 and a substrate (not illustrated).

For example, since a value of the above-described fingerprint capacitor CF varies with a ridge or a valley of the user fingerprint FP, the value of the fingerprint capacitor CF may be very small (e.g., approximately 10 fF). In contrast, a value of a parasitic capacitor between the first metal electrode ME1 and the substrate may be great compared with a value of the fingerprint capacitor CF. In this case, as expressed by Equation 3, a value of the fingerprint capacitor CF may not be accurately detected due to influence of a relatively large parasitic capacitor CS. This may mean that a ridge and a valley are not accurately detected from the user fingerprint FP. In this case, the above-described influence of the parasitic capacitor may be canceled out or removed by maintaining a voltage of the first shielding electrode SE1 positioned under the first metal electrode ME1 to be the same as a voltage of the first metal electrode ME1.

To control a potential of a shielding electrode, a conventional fingerprint sensor controls the potential of the shielding electrode through an active block (e.g., a unit gain buffer) connected between a metal electrode and the shielding electrode in the same fingerprint pixel. In this case, the use of the active block may cause an increase in power consumption. Also, due to a gain difference of active blocks of fingerprint pixels, shielding potentials of the fingerprint pixels may be different from each other, thereby causing an output error of a fingerprint pixel.

The first fingerprint pixel circuit 211 according to the disclosure may control a potential of the first shielding electrode SE1 based on signals provided to peripheral fingerprint pixels, without using an active block. In this case, power consumption may be reduced. Also, since the potential of the first shielding electrode SE1 is controlled by using signals provided to peripheral fingerprint pixels, an error occurring in the first shielding electrode SE1 may be the same as an error occurring in the peripheral fingerprint pixels. Accordingly, an error of each fingerprint pixel may be easily removed or compensated.

For example, in the case where the first fingerprint pixel PIX1 operates as an active pixel, the second fingerprint pixel PIX2 may operate as a shielding pixel. In an example embodiment, the active pixel may indicate a pixel for actually detecting the fingerprint capacitor CF formed by the user fingerprint FP, and the shielding pixel may indicate a pixel for maintaining the same potential as the active pixel for the purpose of maintaining a direction of an electric field from a metal electrode of the active pixel. The shielding pixel may be a pixel adjacent to the active pixel.

In this case, the first metal electrode ME1 of the first fingerprint pixel PIX1 is used as an electrode for detecting the fingerprint capacitor CF formed by the user fingerprint FP. Here, the first shielding electrode SE1 of the first fingerprint pixel PIX1 may not be directly connected with the first metal electrode ME1 and may maintain a specific potential in response to a control signal CTRL (e.g., the high-voltage pulse VHP or a middle high-voltage VHCM) provided from the controller 220. The second metal electrode ME2 and the second shielding electrode SE2 of the second fingerprint pixel PIX2 may be directly connected with each other, and may maintain a specific potential in response to the control signal CTRL (e.g., the high-voltage pulse VHP or a middle high-voltage VHCM) provided from the controller 220.

The above-described control signal CTRL may be provided to the first shielding electrode SE1, the second metal electrode ME2, and the second shielding electrode SE2 through a plurality of switches included in the first fingerprint pixel circuit 211 and the second fingerprint pixel circuit 212.

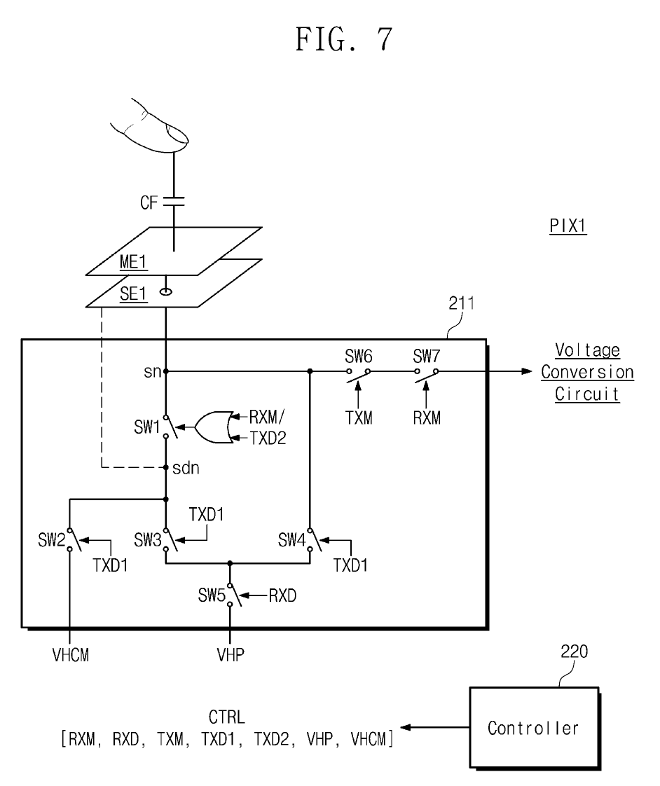

FIG. 7 is a view illustrating the first fingerprint pixel PIX1 of FIG. 6. For a brief description, components that are unnecessary to describe a structure and an operation of the fingerprint pixel PIX1 are omitted. Also, the first fingerprint pixel PIX1 illustrated in FIG. 7 may be applied to the fingerprint sensor 100 described with reference to FIGS. 1 to 5 or the pixel PIX included in the fingerprint sensor 100.

Referring to FIGS. 6 and 7, the controller 220 may output control signals CTRL. In an example embodiment, the control signals CTRL may include a main RX signal RXM, a dummy RX signal RXD, a main TX signal TXM, a first dummy TX signal TXD1, a second dummy TX signal TXD2, the high-voltage pulse VHP, and the middle high-voltage VHCM.

The main RX signal RXM and main TX signal TXM may be signals for selecting an active pixel of fingerprint pixels included in the fingerprint pixel array 210. The dummy RX signal RXD, the first dummy TX signal TXD1, and the second dummy TX signal TXD2 may be signals for selecting shielding pixels. In an example embodiment, the main RX signal RXM and the dummy RX signal RXD may be signals that are provided to select a channel of a row direction in the arrangement of a plurality of fingerprint pixels included in the fingerprint pixel array 210, and the main TX signal TXM, the first dummy TX signal TXD1, and the second dummy TX signal TXD2 may be signals that are provided to select a channel of a column direction in the arrangement of the plurality of fingerprint pixels included in the fingerprint pixel array 210. However, the disclosure is not limited thereto.

The first fingerprint pixel PIX1 may include the first metal electrode ME1, the first shielding electrode SE1, and the first fingerprint pixel circuit 211. The first metal electrode ME1 and the first shielding electrode SE1 are described above, and thus, a detailed description thereof will not be repeated here.

The first fingerprint pixel circuit 211 may include first to seventh switches SW1 to SW7. In an example embodiment, the first to seventh switches SW1 to SW7 may each be a high-voltage switch.

The first switch SW1 may be connected between the sensing node sn and a shielding node sdn. The second switch SW2 may be connected between the shielding node sdn and the middle high-voltage VHCM. A first end of the third switch SW3 may be connected to the shielding node sdn, and a second end thereof may be connected with a first end of the fifth switch SW5. A second end of the fifth switch SW5 may be configured to receive the high-voltage pulse VHP. A first end of the fourth switch SW4 may be connected with the first end of the fifth switch SW5, and a second end thereof may be connected with the sensing node sn. The sixth and seventh switches SW6 and SW7 may be connected in series between the sensing node sn and the voltage conversion circuit 221.

The first switch SW1 may operate in response to an OR combination of an inverted main RX signal RXM/and the second dummy TX signal TXD2. For example, in the case where at least one of the inverted main RX signal RXM/and the second dummy TX signal TXD2 is at a high level, the first switch SW1 may be turned on. As the first switch SW1, the first metal electrode ME1 and the first shielding electrode SE1 may be connected with each other through the first switch SW1. For example, the first shielding electrode SE1 is connected with the shielding node sdn, and the first metal electrode ME1 is connected with the sensing node sn. As the first switch SW1 is turned on, the sensing node sn and the shielding node sdn may be electrically connected, and thus, the first metal electrode ME1 and the first shielding electrode SE1 may be connected with each other.

The second switch SW2 may operate in response to the first dummy TX signal TXD1. For example, the second switch SW2 may provide the middle high-voltage VHCM to the shielding node sdn in response to the first dummy TX signal TXD1 of the high level.

The third and fourth switches SW3 and SW4 may operate in response to the first dummy TX signal TXD1.

The fifth switch SW5 may operate in response to the dummy RX signal RXD. For example, as the fifth switch SW5 is turned on in response to the dummy RX signal RXD of the high level, the high-voltage pulse VHP may be provided between the third and fourth switches SW3 and SW4.

The sixth switch SW6 and the seventh switch SW7 may operate in response to the main TX signal TXM and the main RX signal RXM, respectively. For example, as the sixth switch SW6 and the seventh switch SW7 are respectively turned on in response to the main TX signal TXM of the high level and the main RX signal RXM of the high level, a voltage of the sensing node sn may be provided to the voltage conversion circuit 221.

In an example embodiment, in the case where the first fingerprint pixel PIX1 is an active pixel, the first switch SW1 may be turned off, and the second to seventh switches SW2 to SW7 may be turned on. As the first switch SW1 is turned off, the first shielding electrode SE1 may not be directly connected with the first metal electrode ME1, and a potential of the first shielding electrode SE1 may be adjusted by the middle high-voltage VHCM and the high-voltage pulse VHP. In this case, the middle high-voltage VHCM and the high-voltage pulse VHP may correspond to signals that are provided to peripheral fingerprint pixels (i.e., shielding pixels) adjacent to the active pixel. In other words, not a potential of the first metal electrode ME1 but a potential of the first shielding electrode SE1 may be controlled based on signals that are provided to peripheral fingerprint pixels (i.e., shielding pixels), without using a separate active block.

In an example embodiment, various control signals illustrated in FIG. 7 are exemplary, and the disclosure is not limited thereto. For example, the controller 220 may generate separate switching signals for controlling a plurality of switches included in the first fingerprint pixel circuit 211. Alternatively, to drive a fingerprint sensor according to the disclosure, the controller 220 may group a plurality of switches included in the first fingerprint pixel circuit 211 to generate a switching signal corresponding to each group.

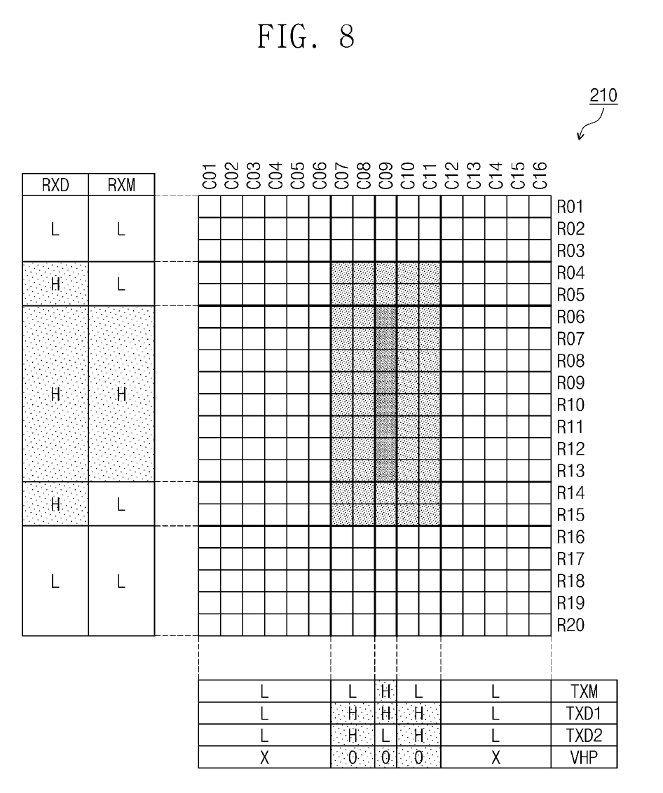

FIG. 8 is a view for describing a driving manner of the fingerprint sensor 200 of FIG. 6. For a brief description, components that are unnecessary to describe a driving manner of a fingerprint sensor according to the disclosure are omitted. For a brief description, it is assumed that the fingerprint pixel array 210 includes a plurality of fingerprint pixels and the plurality of fingerprint pixels are arranged along 1st to 20th rows R01 to R20 and 1st to 16th columns C01 to C16. However, the disclosure is not limited thereto. The number of fingerprint pixels included in the fingerprint pixel array 210 may increase or decrease. Also, the fingerprint pixels included in the fingerprint pixel array 210 may be arranged in various manners instead of row and column directions.

In FIGS. 7 and 8, it is assumed that fingerprint pixels positioned at intersections of the 6th to 13th rows R06 to R13 and the 9th column C09 are active pixels. Here, an active pixel means a fingerprint pixel for actually detecting the fingerprint capacitor CF generated by the user fingerprint FP.

To detect the fingerprint capacitor CF through the active pixels, the controller 220 may generate various control signals CTRL (e.g., RXM, RXD, TXM, TXD1, TXD2, and VHP) as illustrated in FIG. 8.

For example, the controller 220 may provide the main RX signal RXM of the high level to fingerprint pixels arranged at the 6th to 13th rows R06 to R13 and may provide the main RX signal RXM of the low level to the remaining fingerprint pixels (i.e., fingerprint pixels arranged at the rows R01 to R05 and R14 to R20). That is, the main RX signal RXM may be a signal for selecting rows (or channels) where active pixels are disposed.

The controller 220 may provide the dummy RX signal RXD of the high level to fingerprint pixels arranged at the 4th to 15th rows R04 to R15 and may provide the dummy RX signal RXD of the low level to the remaining fingerprint pixels (i.e., fingerprint pixels arranged at the rows R01 to R03 and R16 to R20). That is, the dummy RX signal RXD may be a signal for selecting rows (or channels) where active pixels and shielding pixels are disposed.

The controller 220 may provide the main TX signal TXM of the high level to fingerprint pixels arranged at the 9th column C09 and may provide the main TX signal TXM of the low level to the remaining fingerprint pixels (i.e., fingerprint pixels arranged at the rows C01 to C08 and C10 to C16). That is, the main TX signal TXM may be a signal for selecting a column (or a channel) where active pixels are disposed.

The controller 220 may provide the first dummy TX signal TXD1 of the high level to fingerprint pixels arranged at the 7th to 11th columns C07 to C11 and may provide the first dummy TX signal TXD1 of the low level to the remaining fingerprint pixels (i.e., fingerprint pixels arranged at the columns C01 to C06 and C12 to C16). That is, the first dummy TX signal TXD1 may be a signal for selecting columns where active pixels and shielding pixels are disposed.

The controller 220 may provide the second dummy TX signal TXD2 of the high level to fingerprint pixels arranged at the 7th, 8th, 10th, and 11th columns C07, C08, C10, and C11 and may provide the second dummy TX signal TXD2 of the low level to the remaining fingerprint pixels (i.e., fingerprint pixels arranged at the columns C01 to C06, C09, and C12 to C16). That is, the second dummy TX signal TXD2 may be a signal for selecting columns where shielding pixels are disposed.

The controller 220 may provide the high-voltage pulse VHP (indicated in FIG. 8 by “0”) to fingerprint pixels arranged at the 7th to 11th columns C07 to C11 and may provide the high-voltage pulse VHP (indicated in FIG. 8 by “X”) to the remaining fingerprint pixels (i.e., fingerprint pixels arranged at the columns C01 to C06 and C12 to C16).

In an example embodiment, the way to provide the above-described control signals is exemplary and may be variously changed or modified. For example, the above-described control signals may be variously changed or modified depending on the number of active pixels, the arrangement of a column or row direction, the number of shielding pixels, or the arrangement of the column or row direction.

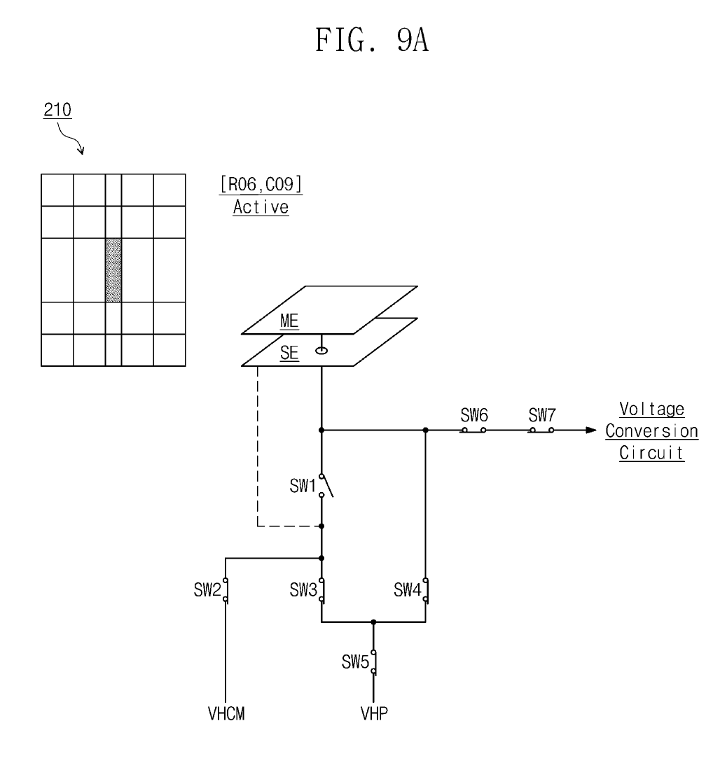

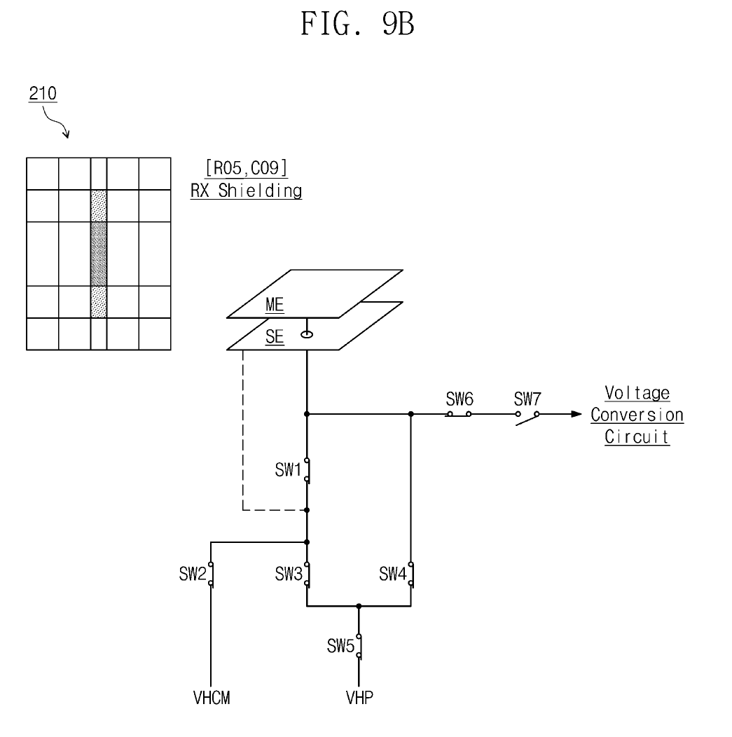

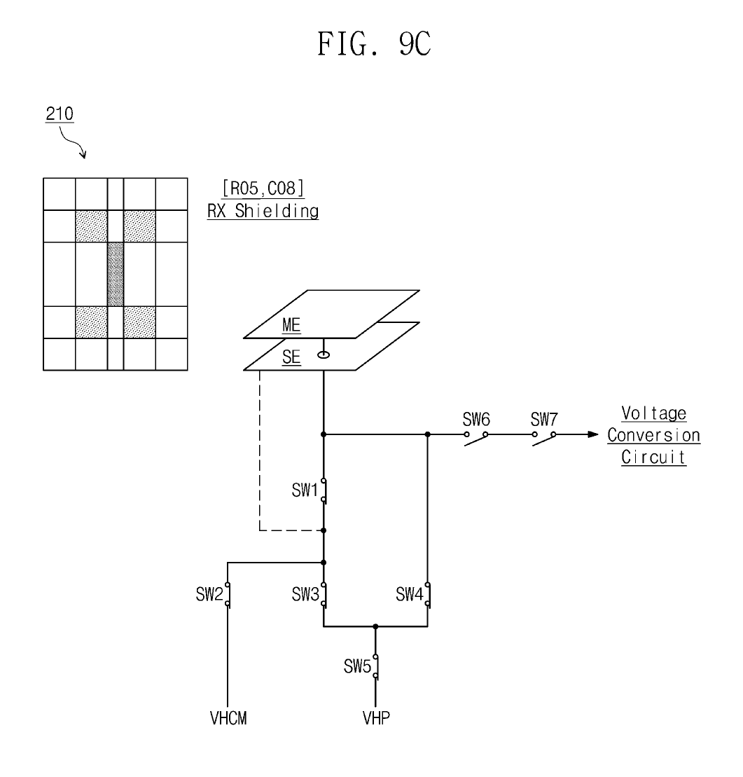

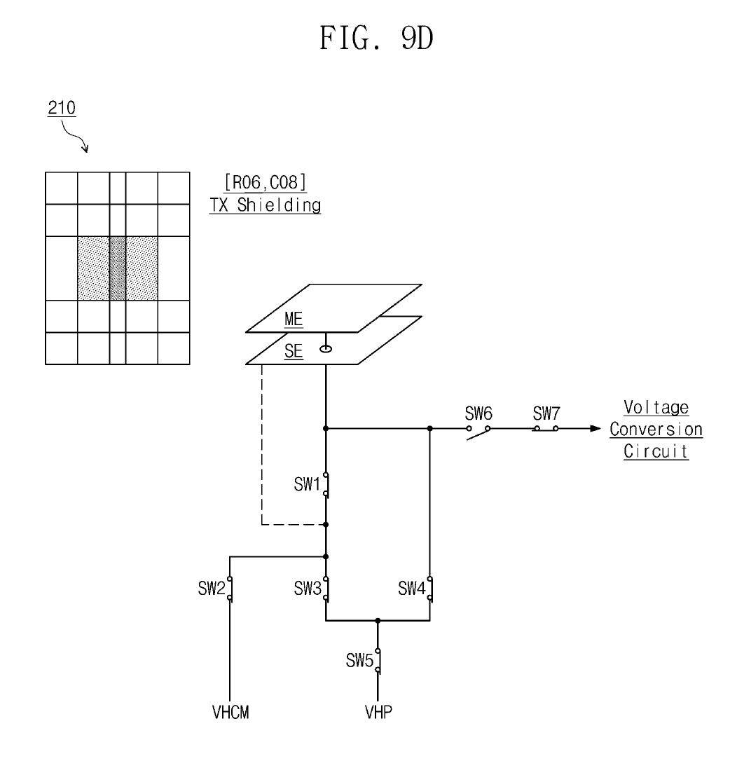

FIGS. 9A to 9D are circuit diagrams illustrating an active pixel and shielding pixels determined depending on control signals illustrated in FIG. 8. For brevity of illustration, in each drawing, signals for driving switches are omitted, and only a configuration of switches turned on or off depending on a control signal is illustrated. Also, for brevity of illustration, locations of fingerprint pixels of FIGS. 9A to 9D will be described with reference to the arrangement of the fingerprint pixel array 210 of FIG. 8.

First, referring to FIGS. 8 and 9A, in an active pixel (e.g., a fingerprint pixel positioned at the 6th row R06 and the 9th column C09), the first switch SW1 is turned off, and the second to seventh switches SW2 to SW7 are turned on. In this case, information about the fingerprint capacitor CF formed on the metal electrode ME by the user fingerprint FP may be provided to the voltage conversion circuit 221.

In an example embodiment, as the first switch SW1 is turned off, the shielding electrode SE may not be directly connected with the metal electrode ME. However, as described above, the shielding electrode SE may maintain a specific potential by the middle high-voltage VHCM and the high-voltage pulse VHP provided to adjacent fingerprint pixels.

Next, referring to FIGS. 8 and 9B, in an RX shielding pixel positioned at the 5th row R05 and the 9th column C09, the seventh switch SW7 is turned off, and the first to sixth switches SW1 to SW6 are turned on. As the seventh switch SW7 is turned off, a voltage of the sensing node sn may not be provided to the voltage conversion circuit 221. As the first to sixth switches SW1 to SW6 are turned on, the metal electrode ME and the shielding electrode SE are directly connected with each other. Each of the metal electrode ME and the shielding electrode SE may maintain a specific potential by the middle high-voltage VHCM and the high-voltage pulse VHP.

Then, referring to FIGS. 8 and 9C, in an RX shielding pixel positioned at the 5th row R05 and the 8th column C08, the sixth and seventh switches SW6 and SW7 are turned off, and the first to fifth switches SW1 to SW5 are turned on. As the sixth and seventh switches SW7 are turned off, a voltage of the sensing node sn may not be provided to the voltage conversion circuit 221. As the first to fifth switches SW1 to SW5 are turned on, the metal electrode ME and the shielding electrode SE are directly connected with each other. Each of the metal electrode ME and the shielding electrode SE may maintain a specific potential by the middle high-voltage VHCM and the high-voltage pulse VHP.

After that, referring to FIGS. 8 and 9D, in a TX shielding pixel positioned at the 6th row R06 and the 8th column C08, the sixth switch SW6 is turned off, and the first to fifth switches SW1 to SW5 and the seventh switch SW7 are turned on. As the sixth switch SW6 is turned off, a voltage of the sensing node sn may not be provided to the voltage conversion circuit 221. As the first to fifth switches SW1 to SW5 are turned on, the metal electrode ME and the shielding electrode SE are directly connected with each other. Each of the metal electrode ME and the shielding electrode SE may maintain a specific potential by the middle high-voltage VHCM and the high-voltage pulse VHP.

Table 1 shows signals provided depending on locations of fingerprint pixels, which are determined based on an active pixel in the fingerprint pixel array 210.

TABLE 1

| Kinds of | | | | | | | |
|---|---|---|---|---|---|---|---|
| fingerprint | Locations of | | | | | | |
| pixels | fingerprint pixels | RXM | RXD | TXM | TXD1 | TDX2 | VHP |
| Active | C09 | H | H | H | H | L | O |
| | R06~R13 | | | | | | |
| RX_Shielding | C09 | L | H | H | H | L | O |
| | R04~R05, | | | | | | |
| | R14~R15 | | | | | | |
| RX_Shielding | C07~C08, | L | H | L | H | H | O |
| | C10~C11 | | | | | | |
| | R04~R05, | | | | | | |
| | R14~R15 | | | | | | |
| TX_Shielding | C07~C08, | H | H | L | H | H | O |
| | C10~C11 | | | | | | |
| | R06~R13 | | | | | | |
| Deactive | C09 | L | L | H | H | L | O |
| | R01~R03, | | (float) | | | | |
| | R16~R20 | | | | | | |
| Deactive | C07~C08, | L | L | L | H | H | O |
| | C10~C11 | | (float) | | | | |
| | R01~R03, | | | | | | |
| | R16~R20 | | | | | | |
| Deactive | C01~C06, | H | H | L | L | L | X |
| | C12~C16 | | | | | | |
| | R06~R13 | | | | | | |
| Deactive | C01~C06, | L | H | L | L | L | X |
| | C12~C16 | | | | | | |
| | R04~R05, | | | | | | |
| | R14~R15 | | | | | | |
| Deactive | C01~C06, | L | L | L | L | L | X |
| | C12~C16 | | (float) | | | | |
| | R01~R03, | | | | | | |
| | R16~R20 | | | | | | |

Also, control signals of Table 1 associated with locations of fingerprint pixels are described with reference to FIG. 8, and thus, a detailed description thereof will not be repeated here.

Table 2 shows potentials of a metal electrode and a shielding electrode in each fingerprint pixel, and the potentials are determined depending on the control signals of Table 1.

TABLE 2

| Kinds of | Locations of | | | ME |
|---|---|---|---|---|
| fingerprint | fingerprint | Potentials of | Potential of shielding | and SE connected |
| pixels | pixels | metal electrodes | electrodes | or disconnected |
| Active | C09 | VH-VHCM-GND | VH-VHCM-GND | X |
| | R06~R13 | | | |
| RX_Shielding | C09 | VH-VHCM-GND | VH-VHCM-GND | ◯ |
| | R04~R05, | | | |
| | R14~R15 | | | |
| RX_Shielding | C07~C08, | VH-VHCM-GND | VH-VHCM-GND | ◯ |
| | C10~C11 | | | |
| | R04~R05, | | | |
| | R14~R15 | | | |
| TX_Shielding | C07~C08, | VH-VHCM-GND | VH-VHCM-GND | ◯ |
| | C10~C11 | | | |
| | R06~R13 | | | |
| Deactive | C09 | FL-VHCM-FL | FL-VHCM-FL | ◯ |
| | R01~R03, | | | |
| | R16~R20 | | | |
| Deactive | C07~C08, | FL-VHCM-FL | FL-VHCM-FL | ◯ |
| | C10~C11 | | | |
| | R01~R03, | | | |
| | R16~R20 | | | |
| Deactive | C01~C06, | FL-FL-FL | FL-FL-FL | X |
| | C12~C16 | | | |
| | R06~R13 | | | |
| Deactive | C01~C06, | FL-FL-FL | FL-FL-FL | ◯ |
| | C12~C16 | | | |
| | R04~R05, | | | |
| | R14~R15 | | | |
| Deactive | C01~C06, | FL-FL-FL | FL-FL-FL | X |
| | C12~C16 | | | |
| | R01~R03, | | | |
| | R16~R20 | | | |

Referring to Table 2, in shielding pixels, since the metal electrode ME and the shielding electrode SE are connected with each other, the metal electrode ME and the shielding electrode SE may have a potential of VH-VHCM-GND.

In contrast, the metal electrode ME and the shielding electrode SE of an active pixel are not connected. However, as described above, since the shielding electrode SE of the active pixel maintains a potential based on signals provided to adjacent fingerprint pixels, the shielding electrode SE may have a potential of VH-VHCM-GND.

As described above, metal electrodes and shielding pixels of shielding pixels adjacent to an active pixel may be maintained at a specific potential by operations of a plurality of switches included in a fingerprint pixel circuit . Also, a shielding electrode of an active pixel may maintain a specific potential by using signals provided to adjacent fingerprint pixels, without using a separate active block. Accordingly, a fingerprint sensor of improved performance is provided with reduced costs.

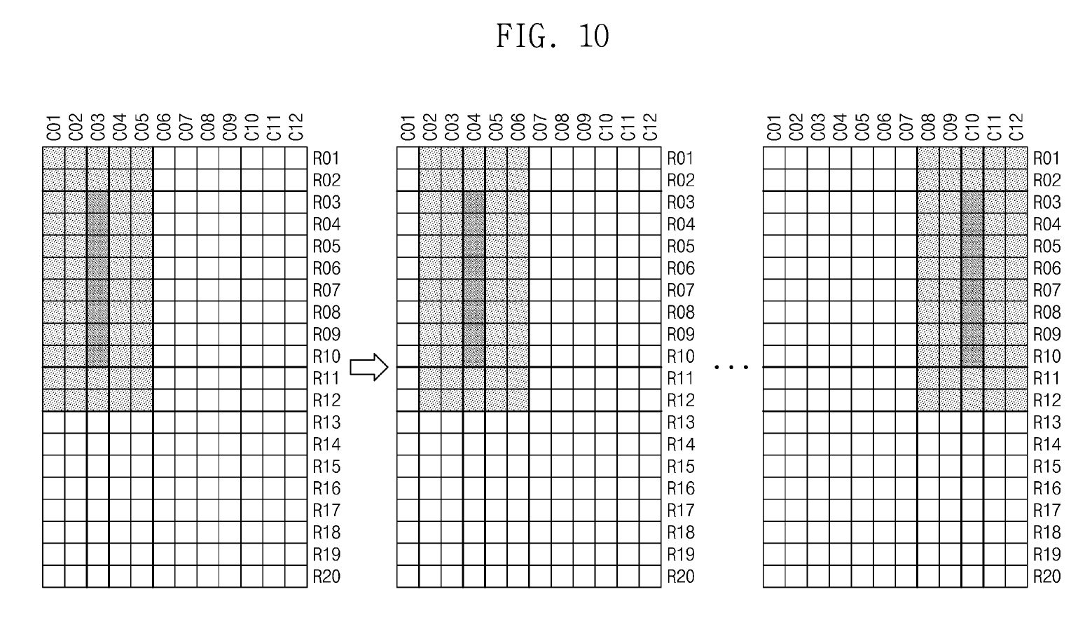

FIG. 10 is a view for describing a driving method of a fingerprint sensor according to the disclosure. For a brief description, a driving method will be described with reference to the fingerprint pixel array 210 of the fingerprint sensor 200. Referring to FIGS. 6 and 10, a part of fingerprint pixels of the fingerprint pixel array 210 may be selected as an active pixel.

For example, fingerprint pixels positioned at intersections of the 3rd to 10th rows R03 to R10 and the 3rd column C03 may be selected as active pixels. In an example embodiment, fingerprint pixels positioned at the periphery of the fingerprint pixel array 210 may be dummy fingerprint pixels for shielding (i.e., shielding-dedicated fingerprint pixels). However, the disclosure is not limited thereto. For example, fingerprint pixels positioned at the periphery of the fingerprint pixel array 210 may also be selected as an active pixel. The controller 220 may generate control signals as described above, such that adjacent fingerprint pixels surrounding the centered active pixel operate as a shielding pixel.

After a fingerprint sensing operation for fingerprint pixels positioned at the 3rd to 10th rows R03 to R10 and the 3rd column C03 are completed, fingerprint pixels (i.e., fingerprint pixels positioned at the 3rd to 10th rows R03 to R10 and the 4th column C04) positioned at a next column may be selected as active pixels. As in the above description, the controller 220 may generate control signals. The fingerprint sensor 200 may repeatedly perform the above-described operation to select fingerprint pixels positioned at the 3rd to 10th rows R03 to R10 and the 10th column C10 may be selected as active pixels.

After performing a fingerprint sensing operation on one channel (i.e., a channel of a row direction), the fingerprint sensor 200 may perform a fingerprint sensing operation on a next channel (i.e., a channel of another row direction). The fingerprint sensor 200 may obtain the full fingerprint image by performing a fingerprint sensing operation on one frame through the iteration of the above-described operation.

In an example embodiment, signals output from active pixels may be provided to a DSP through a voltage conversion circuit , an analog circuit , a multiplexer, and an ADC described above, and the DSP may finally obtain a fingerprint image.

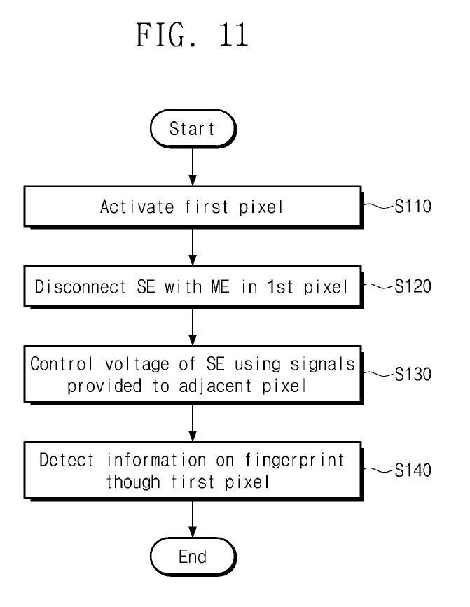

FIG. 11 is a flowchart illustrating a driving method of a fingerprint sensor of FIG. 6. Referring to FIGS. 6 and 11, in operation S110, the fingerprint sensor 200 may activate a first fingerprint pixel. For example, the fingerprint sensor 200 may select the first fingerprint pixel as a fingerprint pixel for detecting the fingerprint capacitor CF formed by the user fingerprint FP as described above.

In operation S120, the fingerprint sensor 200 may disconnect a metal electrode and a shielding electrode of the first fingerprint pixel. In an example embodiment, the disconnection of operation S120 means that a direct connection of the metal electrode and the shielding electrode through the first switch SW1 is interrupted.

In operation S130, the fingerprint sensor 200 may control a potential of the shielding electrode SE by using signals provided to adjacent fingerprint pixels. For example, as described above, the fingerprint sensor 200 may control a potential of the shielding electrode of the first fingerprint pixel by using the middle high-voltage VHCM and the high-voltage pulse VHP provided to adjacent fingerprint pixels.

In operation S140, the fingerprint sensor 200 may detect fingerprint information from the first fingerprint pixel. For example, as described above, the fingerprint sensor 200 may detect information of the fingerprint capacitor CF formed on the metal electrode ME of the first fingerprint pixel.

In FIG. 11, the operation of the fingerprint sensor 200 is piecewise described, which is to describe the technical idea of the disclosure easily. However, the disclosure is not limited thereto. For example, operation S110 to operation S140 may be performed simultaneously or atomically by control signals generated in the fingerprint sensor 200.

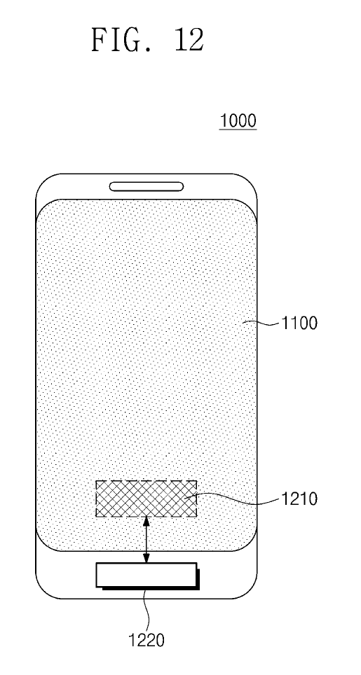

FIG. 12 is a view illustrating an electronic device to which a fingerprint sensor according to an example embodiment of the disclosure is applied. Referring to FIG. 12, an electronic device 1000 may include a panel 1100, a fingerprint pixel array 1210, and a controller 1220.

In an example embodiment, the fingerprint sensor 100/200 described with reference to FIGS. 1 to 11 is described as being implemented with one chip. However, the disclosure is not limited thereto. For example, as illustrated in FIG. 12, the fingerprint pixel array 210 and the controller 1220 may be implemented with a separate semiconductor chip or die.

The fingerprint pixel array 1210 may be included in the panel 1100. For example, the fingerprint pixel array 1210 may be formed on a display panel or a touch panel included in the panel 1100. Alternatively, the fingerprint pixel array 1210 may be implemented with a separate chip and may constitute the panel 1100 together with the display panel or the touch panel.

The fingerprint pixel array 1210 may include pixels described with reference to FIGS. 1 to 10 and may operate in the manner described with reference to FIGS. 1 to 10 under control of the controller 1220.

In an example embodiment, the controller 1220 may control the controller described with reference to FIGS. 1 to 10 or may control the fingerprint pixel array 1210 based on the operation method described with reference to FIGS. 1 to 10.

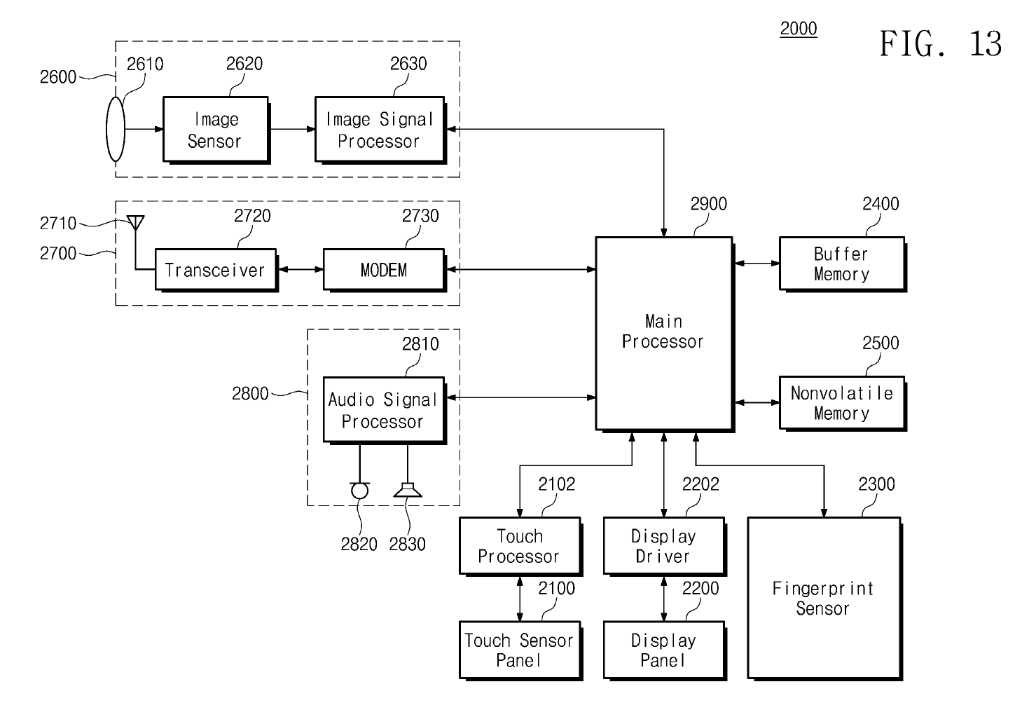

FIG. 13 is a block diagram illustrating an exemplary implementation of an electronic device to which a fingerprint sensor according to the disclosure is applied.

An electronic device 2000 may include a touch sensor panel 2100, a touch processor 2102, a display panel 2200, a display driver 2202, a fingerprint sensor 2300, a buffer memory 2400, a nonvolatile memory 2500, an image processor 2600, a communication block 2700, an audio processor 2800, and a main processor 2900. For example, the electronic device 2000 may be one of various electronic devices such as a portable communication terminal, a personal digital assistant (PDA), a portable media player (PMP), a digital camera, a smartphone, a tablet computer, a laptop computer, and a wearable device.

The fingerprint sensor 2300 may be the fingerprint sensor described with reference to FIGS. 1 to 11. The fingerprint sensor 2300 may include components described above or may operate based on an operation method described above. In an example embodiment, the fingerprint sensor 2300 may be combined with the display panel 2200 or the touch sensor panel 2100.

The buffer memory 2400 may store data that are used to operate the electronic device 2000. For example, the buffer memory 2400 may temporarily store data processed or to be processed by the main processor 2900. For example, the buffer memory 2400 may include a volatile memory such as a static random access memory (SRAM), a dynamic RAM (DRAM), or a synchronous DRAM (SDRAM), and/or a nonvolatile memory such as a phase-change RAM (PRAM), a magneto-resistive RAM (MRAM), a resistive RAM (ReRAM), or a ferroelectric RAM (FRAM).

The nonvolatile memory 2500 may store data regardless of power supply. For example, the nonvolatile memory 2500 may include at least one of various nonvolatile memories such as a flash memory, a PRAM, an MRAM, a ReRAM, and a FRAM. For example, the nonvolatile memory 2500 may include an embedded memory and/or a removable memory of the electronic device 2000.

The image processor 2600 may receive a light through a lens 2610. An image sensor 2620 and an image signal processor 2630 included in the image processor 2600 may generate image information about an external object, based on the received light.

The communication block 2700 may exchange signals with an external device/system through an antenna 2710. A transceiver 2720 and a modulator/demodulator (MODEM) 2730 of the communication block 2700 may process signals exchanged with the external device/system, based on at least one of various wireless communication protocols: long term evolution (LTE), worldwide interoperability for microwave access (WiMax), global system for mobile communication (GSM), code division multiple access (CDMA), Bluetooth, near field communication (NFC), wireless fidelity (Wi-Fi), and radio frequency identification (RFID).

The audio processor 2800 may process an audio signal by using an audio signal processor 2810. The audio processor 2800 may receive an audio input through a microphone 2820 or may provide an audio output through a speaker 2830.

The main processor 2900 may control overall operations of the electronic device 2000. The main processor 2900 may control/manage operations of components of the electronic device 2000. The main processor 2900 may process various operations associated with functions of the electronic device 2000.

A fingerprint sensor according to the disclosure may drive a pixel based on a high-voltage and may drive an analog circuit based on a low-voltage. A signal noise ratio (SNR) may be improved by driving the pixel based on the high-voltage. Also, since the analog circuit operates based on the low-voltage, the analog circuit may operate without a separate external power circuit .

In addition, the fingerprint sensor according to the disclosure may maintain a shielding electrode of an active pixel at a specific potential without a separate active block (e.g., a unit gain buffer). Accordingly, the fingerprint sensor of improved performance is provided with reduced costs.

As is traditional in the field, embodiments may be described and illustrated in terms of blocks which carry out a described function or functions. These blocks, which may be referred to herein as units or modules or the like, are physically implemented by analog and/or digital circuit s such as logic gates, integrated circuit s, microprocessors, microcontrollers, memory circuit s, passive electronic components, active electronic components, optical components, hardwired circuit s and the like, and may optionally be driven by firmware and/or software. The circuit s may, for example, be embodied in one or more semiconductor chips, or on substrate supports such as printed circuit boards and the like. The circuit s constituting a block may be implemented by dedicated hardware, or by a processor (e.g., one or more programmed microprocessors and associated circuit ry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

While the disclosure has been described with reference to exemplary embodiments thereof, it will be apparent to those of ordinary skill in the art that various changes and modifications may be made thereto without departing from the spirit and scope of the disclosure as set forth in the following claims.

1. A fingerprint sensor comprising:
a fingerprint pixel that detects a fingerprint capacitance by a user fingerprint based on a first voltage and outputs fingerprint information corresponding to the fingerprint capacitance through a first node;
a voltage conversion circuit that converts the fingerprint information received through the first node to a converted signal, which is based on a second voltage lower than the first voltage, and outputs the converted signal; and
an analog circuit that outputs an output signal based on the converted signal by using the second voltage.

2. The fingerprint sensor of claim 1, wherein the voltage conversion circuit includes:
a middle capacitor connected between the first node and the analog circuit ;
a first resistor having a first end connected to receive the first voltage;
a second resistor connected between a second end of the first resistor and a ground voltage; and
a middle switch connected between the second end of the first resistor and the first node.

3. The fingerprint sensor of claim 2, wherein a value of the middle capacitor is greater than a value of the fingerprint capacitance.

4. The fingerprint sensor of claim 1, wherein the fingerprint pixel is a capacitive fingerprint pixel that operates based on a passive manner.

5. The fingerprint sensor of claim 4, wherein the fingerprint pixel includes:
a metal electrode that detects the fingerprint capacitance due to the user fingerprint; and
a first high-voltage switch connected between the metal electrode and the first node, wherein
the first high-voltage switch is a switch element based on the first voltage.

6. The fingerprint sensor of claim 5, wherein the fingerprint pixel further includes a shielding electrode, positioned under the metal electrode, that cancels out a parasitic capacitance between the metal electrode and a substrate.

7. The fingerprint sensor of claim 1, wherein the analog circuit includes:
a first low-voltage switch having a first end connected to a ground voltage;
a second low-voltage switch connected between a second end of the first low-voltage switch and the second voltage;
a third low-voltage switch connected between the second end of the first low-voltage switch and the voltage conversion circuit ; and
a capacitor connected between the second end of the first low-voltage switch and the ground voltage, wherein
the first to third low-voltage switches are switch elements based on the second voltage.

8. The fingerprint sensor of claim 7, wherein the analog circuit further includes an integrator that outputs the output signal by accumulating the converted signal.

9. The fingerprint sensor of claim 1, further comprising a control circuit that generates a plurality of switching signals for controlling the fingerprint pixel, the voltage conversion circuit , and the analog circuit .

10. The fingerprint sensor of claim 1, further comprising a voltage generator that generates the first voltage and the second voltage.

11. The fingerprint sensor of claim 1, further comprising:
a multiplexer that multiplexes the output signal to generate a multiplexed output signal;
an analog to digital converter that converts the multiplexed output signal from the multiplexer to a digital signal; and
a digital signal processor that obtains fingerprint image information about the user fingerprint based on the digital signal.

12. A fingerprint sensor comprising:
a first fingerprint pixel including a first metal electrode connected with a sensing node, a first shielding electrode connected with a shielding node, and a first pixel circuit connected with the sensing node and the shielding node; and
a controller that controls the first pixel circuit , wherein
the first pixel circuit includes a first switch, connected between the sensing node and the shielding node, that operates in response to a first control signal or a second control signal from the controller.

13. The fingerprint sensor of claim 12, wherein the first pixel circuit further includes:
a second switch, connected between a middle high-voltage from the controller and the shielding node, that operates in response to a third control signal from the controller;
a third switch, connected between the shielding node and a first node, that operates in response to the third control signal;
a fourth switch, connected between the first node and the sensing node, that operates in response to the third control signal;
a fifth switch, connected between a high-voltage pulse from the controller and the first node, that operates in response to a fourth control signal; and
sixth and seventh switches, connected in series between the sensing node and the controller, that operate in response to a fifth control signal and an inverted signal of the first control signal, respectively.

14. The fingerprint sensor of claim 13, further comprising:
a plurality of fingerprint pixels, wherein:
the first fingerprint pixel and the plurality of fingerprint pixels are arranged along a row direction and a column direction,
the inverted signal of the first control signal is a signal for selecting rows where active pixels of the first fingerprint pixel and the plurality of fingerprint pixels are positioned,
the second control signal is a signal for selecting columns where shielding pixels of the first fingerprint pixel and the plurality of fingerprint pixels are positioned,
the third control signal is a signal for selecting columns where active pixels and shielding pixels of the first fingerprint pixel and the plurality of fingerprint pixels are positioned,
the fourth control signal is a signal for selecting rows where the active pixels and the shielding pixels of the first fingerprint pixel and the plurality of fingerprint pixels are positioned, and
the fifth control signal is a signal for selecting columns where the active pixels of the first fingerprint pixel and the plurality of fingerprint pixels are positioned.

15. The fingerprint sensor of claim 13, wherein in a case where the first fingerprint pixel is an active pixel, the controller generates the first to fifth control signals such that the first switch is turned off and the second to seventh switches are turned on.

16. The fingerprint sensor of claim 13, further comprising:
a second fingerprint pixel adjacent to the first fingerprint pixel, wherein
in a case where the second fingerprint pixel is an active pixel and the first fingerprint pixel is a shielding pixel, the controller generates the first to fifth control signals such that the first to fourth switches are turned on and the sixth or seventh switch is turned off.

17. The fingerprint sensor of claim 16, wherein:
the second fingerprint pixel includes a second metal electrode and a second shielding electrode, and
the second shielding electrode has a same potential as the first metal electrode and the first shielding electrode.

18. The fingerprint sensor of claim 12, wherein:
the first fingerprint pixel operates based on a first voltage, and
the controller includes:
a voltage conversion circuit that converts a signal of the sensing node to a converted signal, which is based on a second voltage lower than the first voltage, and outputs the converted signal, the signal of the sensing node being based on the first voltage; and
an analog circuit that processes the converted signal by using the second voltage.

19. The fingerprint sensor of claim 18, wherein the voltage conversion circuit includes:
a middle capacitor connected between the sensing node and the analog circuit ;
a first resistor having a first end connected to receive the first voltage;
a second resistor connected between a second end of the first resistor and a ground voltage; and
a middle switch connected between the second end of the first resistor and the sensing node.

20. An operation method executed by a fingerprint sensor including a plurality of fingerprint pixels, the method comprising:
activating a first fingerprint pixel of the plurality of fingerprint pixels;
disconnecting a first metal electrode and a first shielding electrode of the first fingerprint pixel;
controlling a potential of the first shielding electrode based on control signals provided to a second fingerprint pixel adjacent to the first fingerprint pixel among the plurality of fingerprint pixels; and
obtaining information about a fingerprint capacitance formed by a user fingerprint from the activated first fingerprint pixel.

21-29. (canceled)
